(19) United States
(12) Patent Application Publication
(10) Pub. No.: US 2011/0279417 A1
(43) Pub. Date: Nov. 17, 2011

(54) DISPLAY PANEL OF A SOLID DISPLAY APPARATUS, FLEXIBLE DISPLAY APPARATUS, AND METHOD OF MANUFACTURING THE DISPLAY APPARATUSES

(75) Inventors: Ki-Nyeng KANG, Yongin-city (KR); Na-Young Kim, Yongin-city (KR)

(73) Assignee: Samsung Mobile Display Co., Ltd., Yongin-city (KR)

(21) Appl. No.: 12/915,804

(22) Filed: Oct. 29, 2010

(30) Foreign Application Priority Data
May 12, 2010 (KR) 10-2010-0044495

(51) Int. Cl. G09G 5/00

(52) U.S. Cl. 345/204

(57) ABSTRACT

A display panel of a solid display apparatus including: a pixel unit having pixels formed on surfaces constituting a polyhedron; scan drive units generating scan signals and supplying the scan signals to the pixels; and data drive units generating data signals according to input images and supplying the data signals to the pixels, wherein the pixel unit is formed on a flexible substrate.

### CROSS-REFERENCE TO RELATED APPLICATION

This application claims the benefit of Korean Patent Application No. 10-2010-0044495, filed May 12, 2010 in the Korean Intellectual Property Office, the disclosure of which is incorporated herein by reference.

### BACKGROUND

1. Field

Aspects of the present invention relate to a solid display apparatus, which includes a display panel of the solid display apparatus, a flexible display apparatus, and a method of manufacturing the solid display apparatus and the flexible display apparatus.

2. Description of the Related Art

Due to recent developments in materials used to form display apparatuses and technology to drive and process data related to display apparatuses, research into thin and flexible display apparatuses has been conducted. A flexible display apparatus includes a flexible substrate formed of plastic or the like, which is bendable or foldable. Flexible display apparatuses are realized on a thin substrate formed of plastic or the like, and thus are not damaged when folded or rolled like a paper. Currently, a flexible display apparatus that has organic light emitting diodes (OLEDs) and liquid display devices having a thickness of 1 mm or less can be manufactured.

### SUMMARY

Aspects of the present invention provide a solid display apparatus, which includes a display panel of the solid display apparatus, a flexible display apparatus, and a method of manufacturing the solid display apparatus and the flexible display apparatus, which minimizes dead space.

According to an aspect of the present invention, there is provided a display panel of a solid display apparatus including a pixel unit having pixels formed on surfaces constituting a polyhedron; scan drive units generating scan signals and supplying the scan signals to the pixels; and data drive units generating data signals according to input images and supplying the data signals to the pixels, wherein the pixel unit is formed on a flexible substrate.

According to another aspect of the present invention, the solid display apparatus has a polyhedron form, and the scan drive units and the data drive units may be disposed on surfaces of the display panel that face an inside of the polyhedron.

According to another aspect of the present invention, the scan drive units and the data drive units may respectively supply scan signals and data signals to the pixel unit in a wireless system.

According to another aspect of the present invention, the solid display apparatus may be formed by folding the surfaces into a polyhedron and bonding the surfaces to each other.

According to another aspect of the present invention, the scan drive units and the data drive units may be approximately parallel to each other.

According to another aspect of the present invention, the solid display apparatus may further include a first wiring layer including first scan signal transmitting wires transmitting a scan signal output from the scan drive units, the first scan signal transmitting wires being aligned in a first direction; a second wiring layer including a plurality of second scan signal transmitting wires transmitting the scan signal received via the first scan signal transmitting wires to the pixels, the second scan signal transmitting wires being aligned in a second direction; and an insulating layer interposed between the first wiring layer and the second wiring layer and including via holes that are formed to expose at least one of the first scan signal transmitting wires and at least one of the second scan signal transmitting wires, wherein the at least one of the first scan signal transmitting wires and the at least one of the second scan signal transmitting wires are connected to each other through at least one of the via holes, and wherein a data signal is transmitted from the data drive units along the first direction.

According to another aspect of the present invention, the solid display apparatus may further include a first wiring layer including first data signal transmitting wires transmitting a data signal output from the data drive units, the first data signal transmitting wires being aligned in a first direction; a second wiring layer including second data signal transmitting wires transmitting the data signal received via the first data signal transmitting wires to the pixels, the second data signal transmitting wires being aligned in a second direction; and an insulating layer interposed between the first wiring layer and the second wiring layer and including via holes formed to expose at least one of the first scan signal transmitting wires and at least one of the second scan signal transmitting wires, wherein the at least one of the first data signal transmitting wires and the at least one of the second data signal transmitting wires are connected to each other through at least one of the via holes, and wherein a scan signal is transmitted from the scan drive units along the first direction.

According to another aspect of the present invention, the plurality of pixels may be consecutively aligned on the surfaces constituting the solid display apparatus.

According to another aspect of the present invention, the plurality of pixels may include organic light emitting diodes (OLEDs).

According to aspects of the present invention, there is provided a flexible display apparatus including a pixel unit including pixels disposed on a flexible substrate that is prepared as a development figure form of a polyhedron; at least one bonding unit formed close to some edges of the flexible substrate prepared as the development figure form of the polyhedron to bond the surfaces of the flexible substrate to each other when the flexible substrate is folded to form the polyhedron; scan drive units generating scan signals and supplying the scan signals to the pixels; and data drive units generating data signals according to input images and supplying the data signals to the pixels.

According to another aspect of the present invention, at least one of the scan drive units and the data drive units may be disposed on the at least one bonding unit.

According to another aspect of the present invention, the pixels may be aligned on surfaces that face an outside of the polyhedron when the flexible display apparatus is folded to form the polyhedron. In addition, the scan drive units and the data drive units may be aligned on surfaces that face an inside of the polyhedron when the flexible display apparatus is folded to form the polyhedron.

According to another aspect of the present invention, the scan drive units and the data drive units may respectively supply scan signals and data signals to the pixel unit in a wireless system.

According to another aspect of the present invention, the scan drive units and the data drive units may be approximately parallel to each other.

According to another aspect of the present invention, the flexible display apparatus may further include a first wiring layer including first scan signal transmitting wires transmitting a scan signal output from the scan drive units, the first scan signal transmitting wires being aligned in a first direction; a second wiring layer including second scan signal transmitting wires transmitting the scan signal received via the first scan signal transmitting wires to the pixels, the second scan signal transmitting wires being aligned in a second direction; and an insulating layer interposed between the first wiring layer and the second wiring layer and including via holes formed to expose at least one of the first scan signal transmitting wires and at least one of the second scan signal transmitting wires, wherein the at least one of the first scan signal transmitting wires and the at least one of the second scan signal transmitting wires are connected to each other through at least one of the via holes, and wherein a data signal is transmitted from the data drive units along the first direction.

According to another aspect of the present invention, the flexible display apparatus may further include a first wiring layer including first data signal transmitting wires transmitting a data signal output from the data drive units, the first data signal transmitting wires being aligned in a first direction; a second wiring layer including second data signal transmitting wires transmitting the data signal received via the first data signal transmitting wires to the pixels, the second data signal transmitting wires being aligned in a second direction; and an insulating layer interposed between the first wiring layer and the second wiring layer and including via holes formed to expose at least one of the first scan signal transmitting wires and at least one of the second scan signal transmitting wires, wherein the at least one of the first data signal transmitting wires and the at least one of the second data signal transmitting wires are connected to each other through at least one of the via holes, and wherein a scan signal is transmitted from the scan drive units along the first direction.

According to another aspect of the present invention, the pixels may be consecutively aligned on the flexible substrate that is prepared in a development figure form of the polyhedron.

According to another aspect of the present invention, the pixels may include organic light emitting diodes (OLEDs).

According to an aspect of the present invention, there is provided a method of manufacturing a display apparatus including forming pixels on a flexible substrate in a development figure form of a polyhedron; forming at least one bonding unit close to some edges of the development figure form of the polyhedron; and cutting the flexible substrate into the development figure form of the polyhedron so as to have the at least one bonding unit.

According to another aspect of the present invention, in order to constitute a solid display apparatus as the display apparatus, the method may further include folding the cut flexible substrate to form the polyhedron; and bonding the at least one bonding unit to an adjacent surface of the polyhedron.

According to another aspect of the present invention, the method may further include forming a sacrificial layer on a glass substrate; and forming a flexible substrate on the sacrificial layer before forming the pixels, and separating the sacrificial layer from the flexible substrate after cutting the flexible substrate.

According to another aspect of the present invention, the method may further include forming scan drive units generating scan signals and supplying the scan signals to the pixels on the development figure form of the polyhedron or on the at least one bonding unit; and forming data drive units generating data signals according to input images and supplying the data signals to the pixels on the development figure form of the polyhedron or on the at least one bonding unit.

According to another aspect of the present invention, the pixels may be formed on surfaces of the polyhedron facing an outside of the polyhedron when the flexible substrate is folded to form the polyhedron in the forming the pixels, wherein the scan drive units are formed on surfaces of the polyhedron that face an inside of the polyhedron when the flexible substrate is folded to form the polyhedron in the forming the scan drive units, and wherein the data drive units are formed on surfaces of the polyhedron that face an inside of the polyhedron when the flexible substrate is folded to form the polyhedron in the forming the data drive units.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a perspective view of a solid display apparatus according to an embodiment of the present invention;

FIG. 2 shows a flexible display apparatus according to an embodiment of the present invention, which is folded to form a solid display apparatus according to an embodiment of the present invention;

FIG. 3 shows a configuration of one surface of a flexible display apparatus according to an embodiment of the present invention; and

FIGS. 4 to 6 are views showing a process of forming a plurality of pixels and driving circuits on a flexible substrate, according to an embodiment of the present invention.

### DETAILED DESCRIPTION

Reference will now be made in detail to the present embodiments of the present invention, examples of which are illustrated in the accompanying drawings, wherein like reference numerals refer to the like elements throughout. The embodiments are described below in order to explain the present invention by referring to the figures.

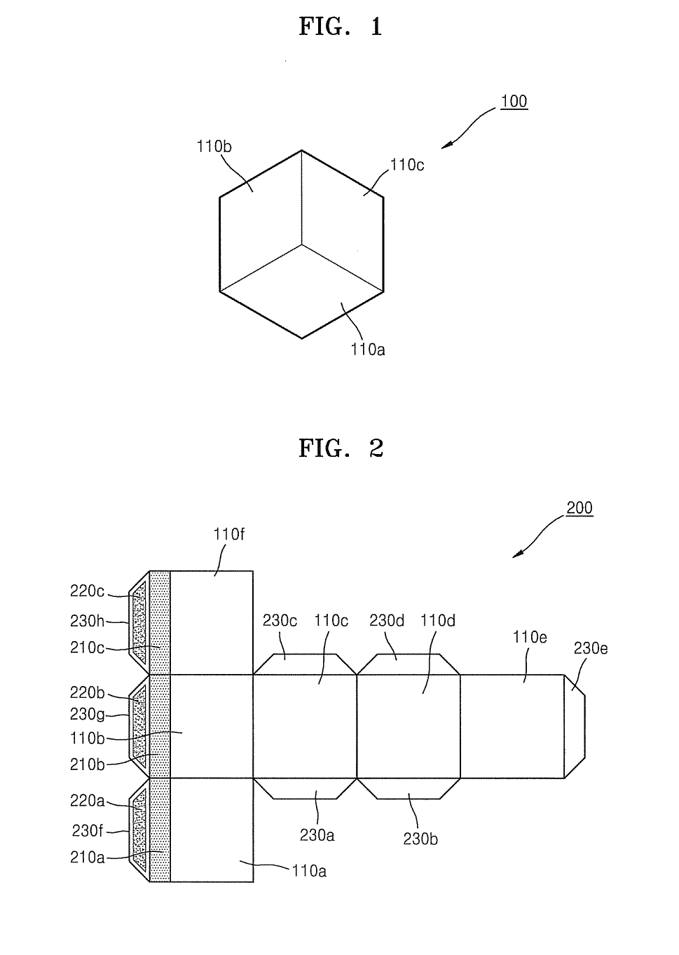

FIG. 1 is a perspective view of a display panel of a solid display apparatus 100 according to an embodiment of the present invention. Conventional display apparatuses are two-dimensional flat panel display apparatuses. According to an embodiment of the present invention, a display panel of the solid display apparatus 100 is provided. The display panel of the solid display apparatus 100 according to the current embodiment has a polyhedral structure. For example, the display panel of the solid display apparatus 100 may have a shape of a tetrahedron, a hexahedron, an octahedron, a polyhedron, a polygonal pillar, a polygonal prism or a polygonal cone.

As shown in FIG. 1, the display panel of the solid display apparatus 100 has surfaces 110a, 110b, and 110c that constitute surfaces of the hexahedron. A plurality of pixels may be formed on the surfaces 110m. 110b, and 110c such that light is emitted from the surfaces 110a, 110b, and 110c of the polyhedron. The display panel of the solid display apparatus 100 displays images in various directions using the surfaces 110a, 110b, and 110c. In addition, a flexible substrate is used in the display panel of the solid display apparatus 100 so that the display panel of the solid display apparatus 100 is bendable or foldable.

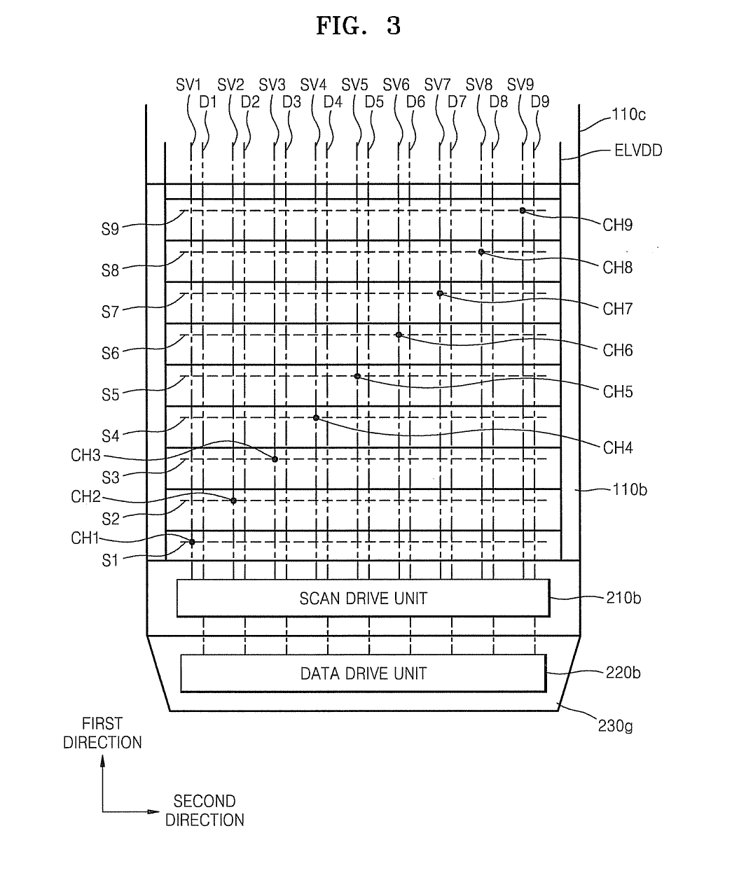

FIG. 2 shows a flexible display apparatus 200 according to an embodiment of the present invention. The flexible display apparatus 200 is folded to form the display panel of the solid display apparatus 100. The display panel of the solid display apparatus 100 may be fabricated by folding the flexible display apparatus 200, that is prepared as a development figure form, into a polyhedral shape and by bonding the flexible display apparatus 200. The flexible display apparatus 200 includes surfaces 110a, 110b, 110c, 110d, 110e, and 110f that constitute surfaces of the polyhedron. The flexible display apparatus 200 also includes scan drive units 210a, 210b, and 210c, data drive units 220a, 220b, and 220c, and bonding units 230a, 230b, 230c, 230d, 230e, 230f, 230g, and 230h.

Pixels are disposed on the surfaces 110a, 110b, 110c, 110d, 110e, and 110f such that light is emitted from the surfaces 110a, 110b, 110c, 110d, 110e, and 110f of the polyhedron. In this regard, the pixels include organic light emitting diodes (OLEDs). The pixels are consecutively aligned on the surfaces 110a, 110b, 110c, 110d, 110e, and 110f. Accordingly, when the flexible display apparatus 200 is folded to form the display panel of the solid display apparatus 100, images may be consecutively displayed on an entire surface of a polyhedron without having dead space.

The scan drive units 210a, 210b, and 210c and the data drive units 220a, 220b, and 220c are disposed on internally facing surfaces of the display panel of the solid display apparatus 100 when the flexible display apparatus 200 is folded to form the polyhedron. Thus, dead space on surfaces facing outside the polyhedron is minimized. In addition, some of or all of the scan drive units 210a, 210b, and 210c and the data drive units 220a, 220b, and 220c are disposed on the bonding units 230a, 230b, 230c, 230d, 230e, 230f, 230g, and 230h. Since the bonding units 230a, 230b, 230c, 230d, 230e, 230f, 230g, and 230h are disposed inside the display panel of the solid display apparatus 100 when the flexible display apparatus 200 is folded to form the polyhedron, dead space may be minimized by disposing the scan drive units 210a, 210b, and 210c and the data drive units 220a, 220b, and 220c on the bonding units 230a, 230b, 230c, 230d, 230e, 230f, 230g, and 230h. Even though FIG. 2 shows that the data drive units 220a, 220b, and 220c are disposed on some of the bonding units 230f, 230g, and 230h, aspects of the present invention are not limited thereto. The scan drive units 210a, 210b, and 210c may also be disposed on the bonding units 230a, 230b, 230c, 230d, 230e, 230f, 230g, and 230h.

The positions of the scan drive units 210a, 210b, and 210c and the data drive units 220a, 220b, and 220c are not limited to those shown in FIG. 2 and may be appropriately disposed so as to minimize dead space on the surfaces facing outside the polyhedron. Additionally, although FIG. 2 shows the flexible display apparatus having three scan drive units 210a, 210b, and 210c and three data drive units 220a, 220b, and 220c, aspects of the present invention are not limited thereto. The numbers of the scan drive units 210a, 210b, and 210c and the data drive units 220a, 220b, and 220c may vary according to embodiments.

In addition, due to limitation of wiring space among the pixels, the scan drive units 210a, 210b, and 210c, and the data drive units 220a, 220b, and 220c, and in order to reduce the dead space on external surfaces of the polyhedron, scan signals and data signals may be supplied from the scan drive units 210a, 210b, and 210c and the data drive units 220a, 220b, and 220c to the pixels using a wireless system. For this, short range wireless communication technology suitable for the scan drive units 210a, 210b, 210c, the data drive units 220a, 220b, and 220c, and the pixels may be applied.

Since the flexible display apparatus 200 is used to form the display panel of the solid display apparatus 100, the flexible display apparatus 200 includes a flexible substrate. Examples of the flexible substrate are a plastic substrate or a stainless steel (SUS) substrate. However, aspects of the present invention are not limited thereto, and other suitable materials may be used as the flexible substrate. In addition, in order to design the flexible display apparatus 200 to have a variety of shapes of the polyhedron, a laser may be used to cut the flexible substrate into a desired shape.

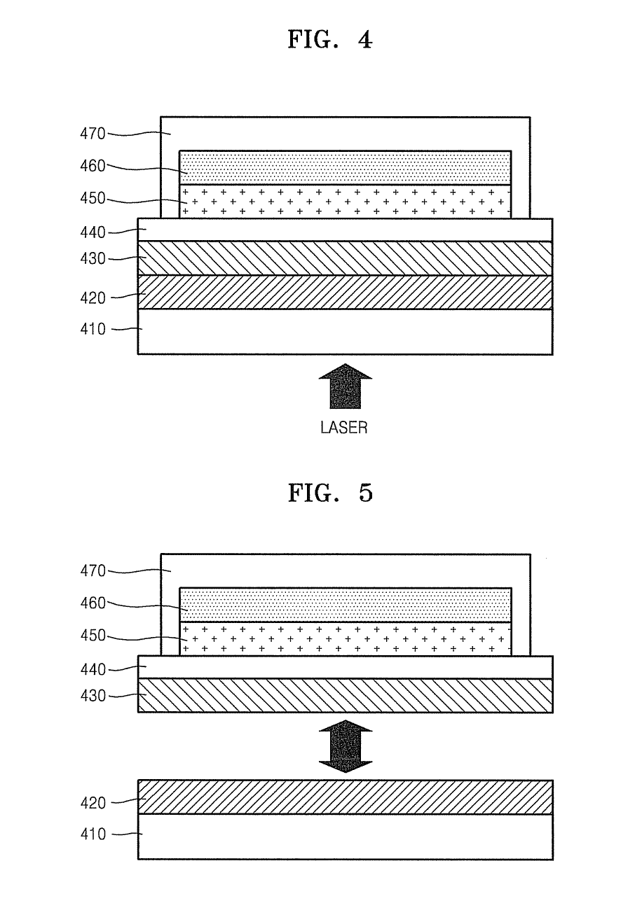

FIG. 3 shows a configuration of one surface of the flexible display apparatus 200 according to an embodiment of the present invention.

According to the present embodiment, as illustrated in FIG. 3, a scan drive unit 210b and a data drive unit 220b are aligned to be approximately parallel to each other. In conventional display apparatuses, scan drive units and data drive units are aligned to be perpendicular to each other, since scan signal wiring and data signal wiring are aligned to be perpendicular to each other. According to the current embodiment, the scan drive units 210a, 210b, and 210c and the data drive units 220a, 220b, and 220c are aligned to be parallel to each other to minimize the influence of folding of the display panel of the solid display apparatus 100 which is applied to the scan drive units 210a, 210b, and 210c and the data drive units 220a, 220b, and 220c. If the scan drive units 210a, 210b, and 210c and the data drive units 220a, 220b, and 220c are aligned to be perpendicular to each other, drive circuits thereof are aligned perpendicular to each other, so that flexible characteristics of the display panel of the solid display apparatus 100 may not be sufficiently used.

On the other hand, if the scan drive units 210a, 210b, and 210c and the data drive units 220a, 220b, and 220c are aligned to be parallel to each other, there is no surface in which the scan drive units 210a, 210b, and 210c and the data drive units 220a, 220b, and 220c are aligned to be perpendicular to each other. Thus, flexible characteristics of the display panel of the solid display apparatus 100 may be sufficiently used. For example, in FIGS. 1 and 2, only the surface 110e includes the scan drive units 210a, 210b, and 210c and the data drive units 220a, 220b, and 220c aligned to be perpendicular to each other. The surfaces 110c and 110d do not include scan drive units 210a, 210b, and 210c and data drive units 220a, 220b, and 220c, and one edge of each of the surfaces 110a, 110b, and 110f includes the scan drive units 210a, 210b, and 210c and the data drive units 220a, 220b, and 220c. Thus, flexible characteristics of the surfaces 110a, 110b, 110d, and 110f close to the surfaces 110c and 110e may be used.

While flexible characteristics of the display panel of the solid display apparatus 100 are used by aligning the scan drive units 210a, 210b, and 210c and the data drive units 220a, 220b, and 220c to be parallel to each other, wiring directions need to be adjusted in order to align scan signal wiring and data signal wiring to be perpendicular to each other. According to an embodiment of the present invention, as shown in FIG. 3, a scan signal that is output from the scan drive unit 210b is transmitted in a first direction via first scan signal transmitting wires SV1 to SV9. The scan signal received via the first scan signal transmitting wires SV1 to SV9 is transmitted in a second direction via second scan signal transmitting wires S1 to S9 to the pixels.

The first scan signal transmitting wires SV1 to SV9 are disposed on a first wiring layer, the second scan signal transmitting wires S1 to S9 are disposed on a second wiring layer, and an insulating layer is interposed between the first wiring layer and the second wiring layer. Via holes CH1 to CH9 are formed between the first wiring layer and the second wiring layer at positions where each of the first scan signal transmitting wires SV1 to SV9 and each of the second scan signal transmitting wires S1 to S9 respectively cross each other. The via holes CH1 to CH9 allow the first scan signal transmitting wires SV1 to SV9 and the corresponding second scan signal transmitting wires S1 to S9 to connect to each other. For example, the via hole CH1 is formed at a position where the first scan signal transmitting wire SV1 meets and connects with the second scan signal transmitting wire S1. The lengths of the first scan signal transmitting wires SV1 to SV9 may be the same so as to make the capacitance of each wire uniform.

A data signal that is output from the data drive unit 220b is transmitted in the first direction via data signal transmitting wires D1 to D9. The pixels are disposed at positions where the second scan signal transmitting wires S1 to S9 and data signal transmitting wires D1 to D9 cross each other. In addition, a power voltage wire ELVDD is disposed to apply power voltage to each pixel.

According to an embodiment, the scan drive units 210a, 210b, and 210c and the data drive units 220a, 220b, and 220c are not disposed on all of the surfaces 110a to 110f. Also, the scan drive units 210a, 210b, and 210c and the data drive units 220a, 220b, and 220c operate the surfaces 110a to 110f of the display panel of the solid display apparatus 100. For example, the scan drive unit 210b and the data drive unit 220b, which are disposed close to the surface 110b, supply scan signals and data signals to the surface 110b and also to the surfaces 110c, 110d, and 110e. Thus, the first scan signal transmitting wires SV1 to SV9 and the data signal transmitting wires D1 to D9 extend to the surfaces 110b, 110c, 110d, and 110e.

Although FIG. 3 shows that the direction of the scan signal transmitting wires SV1 to SV9 and S1 to S9 is changed with respect to a conventional display apparatus, the direction of the data signal transmitting wires may also be changed such that the scan signal is transmitted in the first direction and the data signal is transmitted in the second direction. In other words, the data signal transmitting wires D1 to D9 are aligned in a same manner as the first scan signal transmitting wires SV1 to SV9 and the second scan signal transmitting wires S1 to S9 to transmit the data signal to the pixels along the second direction.

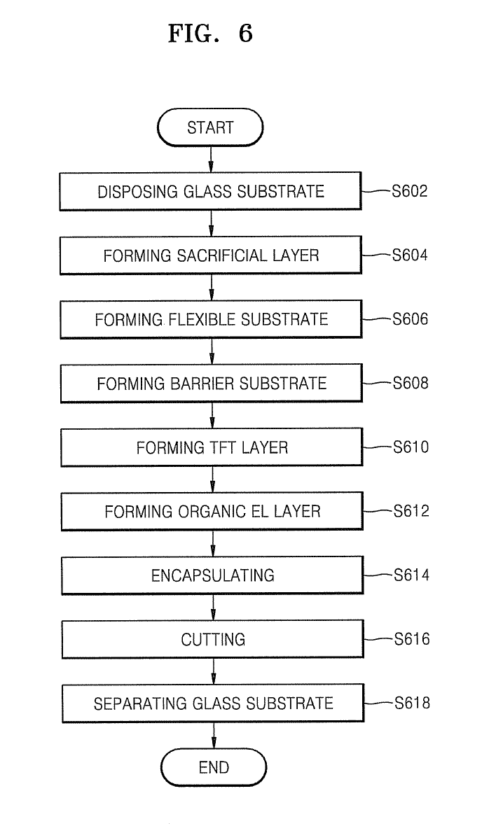

FIGS. 4 to 6 are views showing a process of forming a plurality of pixels and driving circuits on a flexible substrate 430 according to an embodiment of the present invention. The flexible display apparatus 200 includes pixels, scan drive units 210a, 210b, and 210c, and data drive units 220a, 220b, and 220c, all of which are disposed on the flexible substrate 430. However, if the flexible display apparatus 200 is formed on the flexible substrate 430, the flexible substrate 430 may be distorted, denatured, or even break due to heat or pressure applied thereto during a process of manufacturing the flexible display apparatus 200 since the flexible substrate 430 is thin. Thus, the process of manufacturing the flexible display apparatus 200 should be conducted on a flat plate. A glass substrate 410 that supports the flexible substrate 430 is attached to a lower surface of the flexible substrate 430 to manufacture the flexible display apparatus 200.

In operation S602, the glass substrate 410 is disposed or provided, and a sacrificial layer 420 is formed on the glass substrate 410 in operation S604. The sacrificial layer 420 is interposed between the glass substrate 410 and the flexible substrate 430. The sacrificial layer 420 bonds the glass substrate 410 and the flexible substrate 430. The sacrificial layer 420 is later detached therefrom when the flexible substrate 430 is separated from the glass substrate 410 without damaging the flexible substrate 430. The sacrificial layer 420 is formed of indium zinc oxide (IZO), titanium (Ti), molybdenum (Mo), gallium oxide (GaOₓ), indium tin oxide (ITO), amorphous silicon, or the like.

In operation S606, the flexible substrate 430 is formed on the sacrificial layer 420. The flexible substrate 430 is formed of plastic or SUS or another suitable material.

In operation 608, a barrier substrate 440 is formed on the flexible substrate 430. The flexible substrate 430 formed of plastic, or the like and may include impurities or foreign substances. Thus, the barrier substrate 440 is formed on the flexible substrate 430 in order to prevent the impurities or foreign substances from penetrating into a thin film transistor (TFT) layer 450, an organic electroluminescent (EL) layer 460, or the like, which will be formed later.

In operation S610, the TFT layer 450 is formed on the barrier substrate 440, and in operation S612 the organic EL layer 460 is formed on the TFT layer 450. The TFT layer 450 and the organic EL layer 460 have patterns to form a plurality of pixels. The scan drive units 210a, 210b, and 210c and the data drive units 220a, 220b, and 220c are formed on the TFT layer 450. In addition, the first and second scan signal transmitting wires SV1 to SV9 and S1 to S9 and the data signal transmitting wires D1 to D9, which are described above with reference to FIG. 3, are formed on the TFT layer 450.

The scan drive units 210a, 210b, and 210c and the data drive units 220a, 220b, and 220c are formed on a same surface having the pixels. However, aspects of the present invention are not limited thereto. The scan drive units 210a, 210b, and 210c and the data drive units 220a, 220b, and 220c are also be formed on the surface that is opposite to the pixels emitting light after separating the flexible substrate 430 from the glass substrate 410, i.e., the surface that faces inside the polyhedron. According to another embodiment, the scan drive units 210a, 210b, and 210c and the data drive units 220a, 220b, and 220c are formed as a separate drive integrated circuit (IC) chip, which is connected to the flexible substrate 430 by taping, or the like, after the flexible substrate 430 is separated from the glass substrate 410.

If the flexible display apparatus 200 is a liquid crystal display (LCD) apparatus, a liquid crystal layer may be used instead of the organic EL layer 460 and the flexible display apparatus 200 may further include an electrode to drive the liquid crystal layer. When the TFT layer 450 and the organic EL layer 460 are formed, in operation S614, an encapsulating layer 470 is formed on the TFT layer 450 and the organic EL layer 460. The encapsulating layer 470 may have flexibility and may be formed in a thin film encapsulation form as shown in FIG. 4.

Then, in operation S616, the stacked layers are cut into a development figure form of the polyhedron including the bonding units 230a, 230b, 230c, 230d, 230e, 230f, 230g, and 230h. According to an embodiment of the present invention, the stacked layers may be cut into a desired form by laser cutting. However, aspects of the present invention are not limited thereto, and other suitable methods of cutting the stacked layers may be used. In operation S618, the flexible substrate 430 is separated from the glass substrate 410 as shown in FIG. 5. For example, as shown in FIG. 4, the sacrificial layer 420 and the flexible substrate 430 are separated from each other by irradiating laser beams from the glass substrate 410 side. Alternately, the sacrificial layer 420 may be mechanically separated from the flexible substrate 430.

As described above, according to aspects of the present invention, a display panel of a solid display apparatus is provided by forming pixels on a flexible substrate. Furthermore, a display panel of a solid display apparatus having a polyhedral structure is manufactured by consecutively aligning pixels on a flexible substrate, disposing scan drive units and data drive units on surfaces facing an inside of the polyhedron, so that dead space can be minimized on surfaces facing an outside of the polyhedron.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A display panel of a solid display apparatus comprising:
a pixel unit having pixels formed on surfaces constituting a polyhedron;
scan drive units generating scan signals and supplying the scan signals to the pixels; and
data drive units generating data signals according to input images and supplying the data signals to the pixels,
wherein the pixel unit is formed on a flexible substrate.

2. The display panel of claim 1, wherein the solid display apparatus has a polyhedron form, and the scan drive units and the data drive units are disposed on surfaces of the display panel that face an inside of the polyhedron.

3. The display panel of claim 1, wherein the scan drive units and the data drive units respectively supply scan signals and data signals to the pixel unit in a wireless system.

4. The display panel of claim 1, wherein the solid display apparatus is formed by folding the surfaces into a polyhedron and bonding the surfaces to each other.

5. The display panel of claim 1, wherein the scan drive units and the data drive units are approximately parallel to each other.

6. The display panel of claim 5, further comprising:
a first wiring layer having first scan signal transmitting wires transmitting a scan signal output from the scan drive units, the first scan signal transmitting wires being aligned in a first direction;
a second wiring layer having second scan signal transmitting wires transmitting the scan signal received via the first scan signal transmitting wires to the pixels, the second scan signal transmitting wires being aligned in a second direction; and
an insulating layer interposed between the first wiring layer and the second wiring layer and having via holes formed to expose at least one of the first scan signal transmitting wires and at least one of the second scan signal transmitting wires,
wherein the at least one of the first scan signal transmitting wires and the at least one of the second scan signal transmitting wires are connected to each other through at least one of the via holes, and
wherein a data signal is transmitted from the data drive units along the first direction.

7. The display panel of claim 5, further comprising:
a first wiring layer having first data signal transmitting wires transmitting a data signal output from the data drive units, the first data signal transmitting wires being aligned in a first direction;
a second wiring layer having second data signal transmitting wires transmitting the data signal received via the first data signal transmitting wires to the pixels, the second data signal transmitting wires being aligned in a second direction; and
an insulating layer interposed between the first wiring layer and the second wiring layer and having via holes formed to expose at least one of the first scan signal transmitting wires and at least one of the second scan signal transmitting wires,
wherein the at least one of the first data signal transmitting wires and the at least one of the second data signal transmitting wires are connected to each other through at least one of the via holes, and
wherein a scan signal is transmitted from the scan drive units along the first direction.

8. The display panel of claim 1, wherein the pixels are consecutively aligned on the surfaces constituting the solid display apparatus.

9. The display panel of claim 1, wherein the pixels comprise organic light emitting diodes (OLEDs).

10. A flexible display apparatus comprising:
a pixel unit having pixels disposed on a flexible substrate that is prepared as a development figure form of a polyhedron;
at least one bonding unit formed close to some edges of the flexible substrate prepared as the development figure form of the polyhedron to bond the surfaces of the flexible substrate to each other when the flexible substrate is folded to form the polyhedron;
scan drive units generating scan signals and supplying the scan signals to the pixels; and
data drive units generating data signals according to input images and supplying the data signals to the pixels.

11. The flexible display apparatus of claim 10, wherein at least one of the scan drive units and the data drive units is disposed on the at least one bonding unit.

12. The flexible display apparatus of claim 10, wherein the pixels are aligned on surfaces that face an outside of the polyhedron when the flexible display apparatus is folded to form the polyhedron.

13. The flexible display apparatus of claim 10, wherein the scan drive units and the data drive units are aligned on surfaces that face an inside of the polyhedron when the flexible display apparatus is folded to form the polyhedron.

14. The flexible display apparatus of claim 10, wherein the scan drive units and the data drive units respectively supply scan signals and data signals to the pixel unit in a wireless system.

15. The flexible display apparatus of claim 10, wherein the scan drive units and the data drive units are approximately parallel to each other.

16. The flexible display apparatus of claim 15, further comprising:
a first wiring layer having first scan signal transmitting wires transmitting a scan signal output from the scan drive units, the first scan signal wires being aligned in a first direction;
a second wiring layer having second scan signal transmitting wires transmitting the scan signal received via the first scan signal transmitting wires to the pixels, the second scan signal transmitting wires being aligned in a second direction; and
an insulating layer interposed between the first wiring layer and the second wiring layer and having via holes formed to expose at least one of the first scan signal transmitting wires and at least one of the second scan signal transmitting wires,
wherein the at least one of the first scan signal transmitting wires and the at least one of the second scan signal transmitting wires are connected to each other through at least one of the via holes, and
wherein a data signal is transmitted from the data drive units along the first direction.

17. The flexible display apparatus of claim 15, further comprising:
a first wiring layer having first data signal transmitting wires transmitting a data signal output from the data drive units, the first data signal transmitting wires being aligned in a first direction;
a second wiring layer having second data signal transmitting wires transmitting the data signal received via the first data signal transmitting wires to the pixels, the second data signal transmitting wires being aligned in a second direction; and
an insulating layer interposed between the first wiring layer and the second wiring layer and having via holes formed to expose at least one of the first scan signal transmitting wires and at least one of the second scan signal transmitting wires,
wherein the at least one of the first data signal transmitting wires and the at least one of the second data signal transmitting wires are connected to each other through at least one of the via holes, and
wherein a scan signal is transmitted from the scan drive units along the first direction.

18. The flexible display apparatus of claim 10, wherein the pixels are consecutively aligned on the flexible substrate that is prepared in a development figure form of the polyhedron.

19. The flexible display apparatus of claim 10, wherein the pixels comprise organic light emitting diodes (OLEDs).
